(19) United States
(12) Patent Application Publication
(10) Pub. No.: US 2006/0087570 A1
(43) Pub. Date: Apr. 27, 2006

(54) IMAGE SENSING DEVICE WITH PIXEL CORRECTION FUNCTION AND METHOD FOR CORRECTING PIXEL SENSING DATA IN IMAGE SENSING DEVICE

(76) Inventors: Kuo-Yu Chou, Hsinchu County (TW); Chih-Hua Tsai, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/905,969

(22) Filed: Jan. 28, 2005

(30) Foreign Application Priority Data
Oct. 21, 2004 (TW) 93131937

(51) Int. Cl. H04N 9/64

(52) U.S. Cl. 348/246

(57) ABSTRACT

An image sensing device includes a pixel sensing data processing unit, for receiving a pixel line sensing data to output first and second outputs. A controller receives the first output from the pixel sensing data processing unit, checks whether the pixel line sensing data include at least one defective pixel. If it has defective pixel, a correction rule is applied to compare the status data with a previously defective pixel. The correction rule includes comparing a state data of the previous defect pixels. If the defective pixel belongs to a regular pattern, the defective pixel is not corrected. A correction unit receives the second output and receives the correction status from the controller, and to correct the pixel and exports a display data. A recording unit records the status data of the defective pixel detected by the controller for comparing the status data of the next pixel line sensing data.

### CROSS-REFERENCE TO RELATED APPLICATION

This application claims the priority benefit of Taiwan application serial no. 93131937, filed Oct. 21, 2004.

### BACKGROUND OF THE INVENTION

1. Field of the Invention

This invention generally relates to an image sensing technology, and especially relates to an image sensing device with pixel correction function and method for correcting pixel sensing data in an image sensing device.

2. Description of Related Art

Image is indispensable information in our daily life to record or express our day-to-day activities. In the past, analog cameras are main tools to take images. Following the development of electronic technology and semiconductor manufacturing technology, digital cameras are getting popular and will probably replace analog cameras in the foreseeable future.

The characteristics of digital camera as an example is that the image sensing structure includes multiple image sensors arranged in a matrix and taking a pixel as a unit; that is, a dot matrix. Each pixel senses the corresponding color and brightness. Monochromatic image is formed from one image sensor, and the color image is formed from three image sensors corresponding to three primary colors, for example.

However, the image sensor, which has more than 100,000 pixels, would have some defective pixels among them. The color sensed by the defective pixels is shown with a dark or a bright spot. Therefore, these defective pixels would substantially decrease image quality.

In a conventional method of preventing the defective pixel, when the dark or bright spot is found, a good pixel value is used to replace erroneous pixel value of the defect pixel. Alternatively, the average value of multiple good pixel values near the defective pixel serve as the actual display pixel value of the defective pixel.

In image sensors, the image is processed by an image pixel line as a processing frame. The one pixel line includes individual pixel data of multiple pixels. In a conventional method of preventing the defect pixel, it is necessary to record all the pixel data of all pixels of the previous pixel line into a buffer to serve as a reference for correcting the defective pixel. In the U.S. Pat. No. 6,737,625, some methods for processing the defective pixels are also disclosed. These conventional methods, however, would take up a large space in the chip area, and also increase the cost of the chips.

Moreover, in the conventional correcting methods, some regular patterns which are a portion of actual image would be taken as defective pixels, and these regular patterns are processed to cause distorted image display, as shown in FIGS. 1, 2A and 2B.

FIG. 1 is a schematic diagram showing an image for an actual object to be taken. In the actual image 100, an object 104 is positioned before a background of regular black or bright patterns, such as a lattice background 102. In the lattice, some of the pixel values sensed by the image sensors are probably less than a lower threshold value and are viewed as the defective dark spots, or higher than an upper threshold value and are viewed as defective bright spots. Through the conventional correcting process, these lattices are probably deleted or weaken (not shown), such as the image sensing area 106 in FIG. 2A. Even, the lattice in the vertical direction is deleted, as shown in FIG. 2B.

Therefore, the conventional processing methods would occupy a large space in the chip and increase the cost of chips. Moreover, in the conventional methods for correcting pixels, some bright or dark spots of regular patterns would be taken as defective pixels and are inappropriately processed.

### SUMMARY OF THE INVENTION

One object of the present invention is to provide an image sensing device with pixel correction function, which is capable of reducing chip area and manufacturing cost of the chip.

The other object of the present invention is to provide an image sensing device with pixel correction function, which is capable of preventing dark or bright spots in regular patterns from being taken as defective pixels, and are inappropriately processed.

The present invention provides an image sensing device with pixel correction function, comprising a pixel sensing data processing unit, a controller, a correction unit and a recording unit. The pixel sensing data processing unit receives pixel line sensing data which include multiple pixel sensing data, and outputs a first output and a second output. The controller receives the first output from the pixel sensing data processing unit, and checks whether the pixel line sensing data include at least one defective pixel. If there is at least one defective pixel, a correction rule is applied to compare it with the status data of a previous defective pixel. If the defective pixel belongs to a regular pattern, then pixel is not corrected, and a correcting status is output. The correction unit receives the second output from the sensing data pixel processing unit and receives the correcting status of the defective pixel from the controller, to correct or to not correct the defective pixel, and then outputs a display data. The recording unit records the status data of the recent defective pixel detected by the controller, provides the data to the controller for comparing it with the status data when processing the next pixel line sensing data.

In the present invention, according to advanced technology, the status data of the defective pixel include non-defective pixel, or one dimension position data and dark/bright spot data.

In the present invention, according to advanced technology, the recording unit records only one status data of the defective pixel.

In the present invention, according to advanced technology, the regular pattern is a regular pattern of bright spots or a regular pattern of bright spots, for example.

In the present invention, according to advanced technology, the recording unit records multiple status data of the defective pixel.

This present invention also provides a method for correcting the defective pixel data, wherein when receiving a pixel line which includes multiple pixel sensing data, the defective pixel sensing data are corrected. The method comprises: (1) Determining whether the received pixel line includes at least one currently defective pixel; (2) if there is the currently defective pixel determined at the step (1), determining whether the currently defective pixel is a regular pattern after comparing it with a stored previously defective pixel; (3) if it is determined to be a regular pattern at the step (1), maintaining a status data of the pixel without correcting it; (4) if it is determined not be to a regular pattern at the step (1), suitably correcting the current defective pixel by referring to the pixels in the front and back of the currently defective pixel; (5) recording a pixel line data of the pixel line to add the previously defective pixel, and replacing a further previous pixel data of the previously defective pixel when the currently defective pixel exceeds a preset capacity; (6) if the determination in the step (1) is negative or the pixel line is corrected through the steps (2) to (4), performing a pixel processing step; (7) if there is a next pixel line to be displayed, the process going back to the step (1), otherwise the process ends.

In the method for correcting pixel of the present invention, according to advanced technology, the preset capacity in the step (5) includes only one previous pixel line data.

In the method for correcting pixel of the present invention, according to advanced technology, the step (2) comprises: (2.1) Determine whether a previous pixel line includes the defective pixel; (2.2) If the determination in the step (2.1) is negative, go to the step (4); (2.3) If the determination in the step (2.1) is positive, compare whether the currently defective pixel with the previously defective pixel to see if they are identical; (2.4) If the determination in the step (2.3) is negative, go to the step (4); (2.5) If the determination in the step (2.3) is positive, go to the step (3).

### BRIEF DESCRIPTION OF THE DRAWINGS

The above is a brief description of some deficiencies in the prior art and advantages of the present invention. Other features, advantages and embodiments of the invention will be apparent to those skilled in the art from the following description, accompanying drawings and appended claims.

FIG. 1 is a schematic view showing an actual object to be taken as an image.

FIGS. 2A and 2B are schematic views showing the actual object in FIG. 1 taken as an image.

FIG. 3 is a block diagram of an image sensing system with pixel correcting function according to one embodiment of the present invention.

FIG. 4 shows a brief flow chart of the method for correcting pixel according to one embodiment of the present invention.

FIG. 5 shows a general flow chart of the method for correcting pixel according to one embodiment of the present invention.

### DESCRIPTION OF THE EMBODIMENTS

The present invention can at least reduce pixel buffer capacity which is used in correcting the defective pixel detected by the defective sensing unit, and reduce the chip area of the image sensing device. Moreover, the present invention also provides a suitable method for correcting the defective pixel, which can avoid the disadvantages in the prior art wherein the regular bright or dark patterns inherent in the images are corrected as defective pixels and cause the poor display quality.

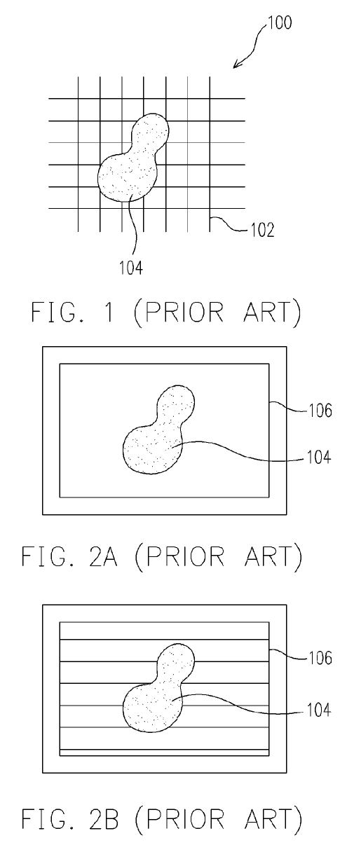

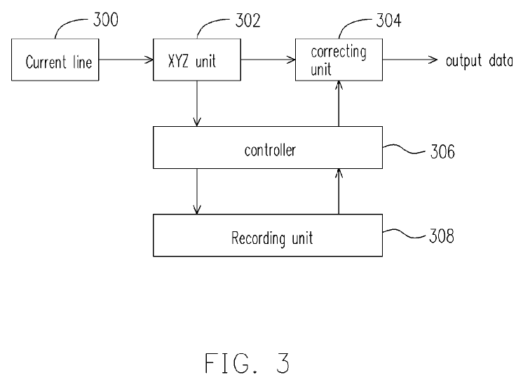

As to a circuit device, FIG. 3 is a block diagram showing an image sensing system with pixel correcting function according to one embodiment of the present invention. In FIG.3, an image is sensed by pixel lines and is inputted and processed as a frame. The pixel in the following means the pixel data sensed by a sensing device. The block 300 represents a pixel line sensing data to be input and processed. A pixel data processing unit, called XYZ unit 302, receives the pixel line sensing data of the pixel line. The pixel line data includes individual pixel data of multiple pixels. These pixels possibly include at least a defective pixel, or a bright or dark pixel of the regular bright or dark pattern, such as the pattern in the lattice background 102 in FIG. 1. The XYZ unit 302 outputs the pixel line sensing data to a controller 306 and a correcting unit 304, accordingly.

The controller 306, after receiving the pixel output data from XYZ unit 302, determines whether or not the pixel line data includes at least a defective pixel. Herein, the determination of a defective pixel line data depends on whether or not the pixel value is less than a lower threshold value or higher than an upper threshold value. The pixel is viewed as a dark pixel if the pixel value is less than the lower threshold value, and as a bright pixel if the pixel value is higher than the upper threshold value. If there is at least a defective pixel, a correcting value is provided to the defect pixel according to a correction rule. The correction rule includes the method of comparing the status data with that of the previously defective pixel, and the defective pixel is not corrected if it belongs to a regular pattern.

In the above, the method of comparing the status data with that of the previously defective pixel is to compare the bright or dark state, and the one dimension position on the pixel line. Herein, the previously defective pixel is stored in a recording unit 308, the function of which is described in the following. For example, if the status of the currently defective pixel is the same as that of the previous pixel line, then the defective pixel is probably belonging to a vertical dark/bright pixel line and is not corrected. If the status of the currently defective pixel is not the same as the previous pixel line, which might be detected by the defective pixel sensing device, then the controller 306 outputs the correcting status to a correcting unit 304.

The correcting unit 304 receives the pixel data output of the XYZ unit 302, receives the output of the controller 306, and then corrects the defective pixel. Herein, the controller 306 mainly determines whether there are pixels determined as defective pixels, and further determines whether the currently defective pixels should be maintained or corrected. The correcting unit 304 receives the output of the controller 306. When correction is needed, a normal correcting method can be performed. According to the actual design, the controller 306 can also provide the correcting value, and outputs it directly to the correcting unit 304 for correcting the pixel. That is, in fact the function of the correcting unit 304 and the controller 306 can be integrated in one block.

A recording unit 308 records the status data of the currently defective pixel detected by the controller 306, and provides the data to the controller 306 for comparing the state data when processing the next pixel line sensing data.

In the above, when processing the first pixel line, since there is no previous pixel line data, the status data is determined by the status of the first pixel line. This is an initial process and can be decided according to an actual design.

In the above, the status data of the defective pixel includes the status of non-defective pixel, or one dimension position data, and bright/dark spot data.

In the above, in a simpler method, the recording unit 308 only records the status data of the defective pixel in one pixel line, so that the storage capacity of the recording unit 308 can be substantially reduced and the chip area can be downsized. And the regular pattern can be for example, a regular bright spot pattern or a regular dark spot pattern, or a vertical lattice, a horizontal lattice, or a vertical-horizontal crisscrossing lattice.

In the above, the recording unit 308 can also record the defective pixels of several previous pixel lines for determining whether the currently defective pixel is a regular curve, such as an arc line. The defective pixel data with suitable pixel line number can be decided according to the actual design, wherein the defective pixel data could be five or less than five previous pixel line data. According to geometric principle, any three points can constitute an arc. But an arc composed of four or five points would show more regularity. Also, in an oblique line, the defective pixels in the front and back of the pixel are distanced with a regular amount of pixels. These inspecting methods can be integrated into the controller 306 according to the design specification, in conjunction with the record of the recording unit 308.

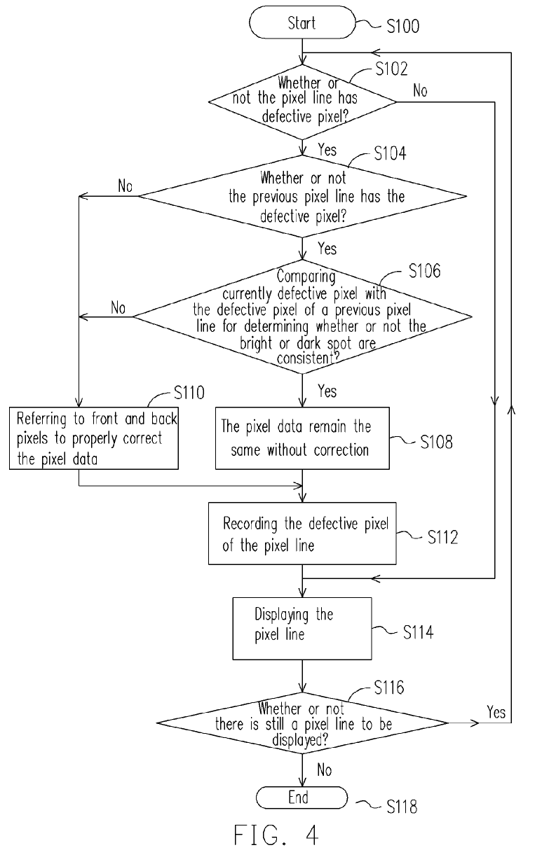

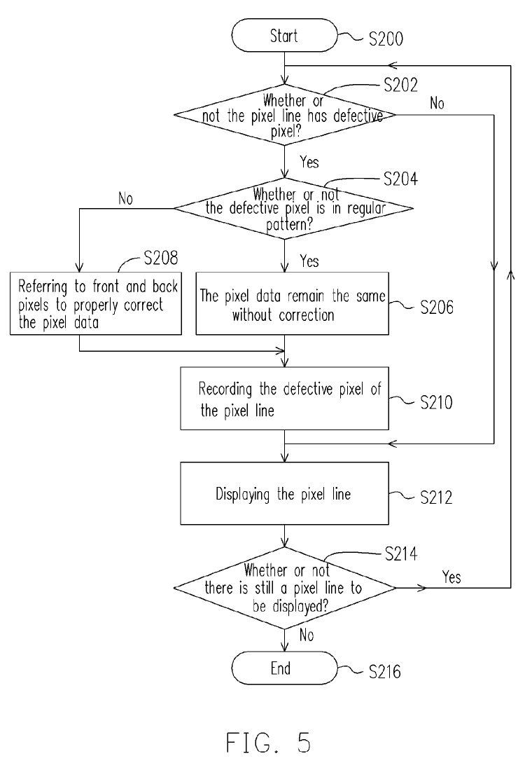

In the operating method, the present invention provides a pixel correcting method for correcting the defective pixels when receiving a pixel line of the multiple pixels. FIG. 4 shows a general flow chart of the pixel correction method according to one embodiment of the present invention. In the following example, the method is applied in a simple situation where only the defective pixel of a previous pixel line is compared. The pixel correcting method comprises the step S100, where the method starts, or some initial preparation begins. Then in step S102, it is determined whether or not the received pixel line includes at least one currently defective pixel. If there is no defective pixel, the process goes to step S114 for displaying the pixel line. If a previous pixel line includes the defective pixel, the process goes to step S104 for checking whether or not the previous pixel line has the defective pixel. If the previous pixel line has the defective pixel, then the process goes to the step 106, otherwise goes to step S110. In step S106, the currently defective pixel is compared with the defective pixel of a previous pixel line for determining whether or not for example the position, bright or dark spot are consistent. If the result of step S106 is consistent, the process goes to step S108, otherwise goes to step S110. In step S110, the pixels in the front and back of the defective pixel are referred to generate a correcting value for correcting pixels. There are also various methods of generating the correcting value, and the value can also be replaced with a perfect pixel in the front or back of the defective pixel.

In step S108, the correction is not made since the currently defective pixel is same with the previous status of the defective pixel in the previous pixel line, including the position and bright/dark spot. In this situation, it possibly for example belongs to the same vertical bright/dark pixel line, so the pixel is not corrected. After finishing the step S108 and the step S110, the process goes to step S112 for recording the status of the currently defective pixel. Then, in step S114, the pixel line is displayed. The recording action in step S112 does not necessarily take place before step S11 4 as shown in FIG. 4, but can be performed after the displaying. Moreover, the displaying in step S114 is taken as an example. It can also be after the pixel processing such as outputting or reserving image data. In steps S116 and S118, it is decided whether to continue or stop the process.

FIG. 4 only shows a situation where the data of a previous data line is recorded by the recording unit 308 (shown in FIG. 3), wherein the lattice is not corrected. In view of general characteristic of the present invention, the regular pattern is not necessary to be a lattice. FIG. 5 shows a general flowchart of the pixel correcting method of the present invention. The steps S200 and S202 are the same with steps S100 and S102 in FIG. 4.

When it is determined that there is a defective pixel, in step S204, the pixel is compared with a stored previously defective pixel to determine whether or not the currently defective pixel belongs to a regular pattern. In step S204, if it is determined that the currently defective pixel is a regular pattern, a status data thereof is maintained and the pixel is not corrected. If it is determined that the currently defective pixel is not a regular pattern, the currently defect pixel is appropriately corrected by referring to the pixels in the front and back of the currently defective pixel. Meanwhile, as mentioned in FIG. 3, the regular pattern is appropriately extended to a larger scale according to the inspecting rule, for inspecting an oblique line, a curve line or other complex regular patterns, so as to avoid these regular patterns from being inappropriately corrected or deleted.

In step S210, a pixel line data of the pixel line is recorded for adding the previously defective pixel. Since the recording unit has a certain amount of capacity, when the previously defective pixel exceeds this capacity, a further previously defective pixel of the previously defective pixel is replaced. In step S212, if the determination in S202 is negative, or if the pixel line is corrected through the steps S204 to S206, the process goes to a pixel processing step for displaying, outputting or storing the pixel. In steps S214 and S216, if there is a next pixel to be displayed, the process goes back to step S202, otherwise the process ends.

In light of the above, the present invention provides an image sensing system with pixel correction function and a method of correcting pixels, wherein the chip area can be reduced, the manufacturing cost of the chips can be decreased, and the bright or dark spots of the regular pattern can be prevented from being determined as defective pixels, and are inappropriately processed.

The above description provides a full and complete description of the embodiments of the present invention. Various modifications, alternate construction, and equivalent may be made by those skilled in the art without changing the scope or spirit of the invention. Accordingly, the above description and illustrations should not be construed as limiting the scope of the invention which is defined by the following claims.

What is claimed is:

1. An image sensing device with pixel correction function, suitable for an image sensing system, the image sensing device comprising:
a sensing pixel data processing unit, for receiving a pixel line sensing data, which comprises multiple pixel data sensed by multiple sensing units, to output a first output and a second output;
a controller, for receiving the first output of the sensing pixel data processing unit, inspecting whether or not the pixel line sensing data contains at least a defective pixel due to the defective sensing unit, and if there is at lest one defective pixel, a correction rule is applied to compare a status data with that of the previously defective pixel, and if the defective pixel belongs to a regular pattern, the defective pixel is not corrected, and a correction status is output;
a correction unit, for receiving the second output from the sensing data pixel processing unit, and receiving the correction status of the defective pixel from the controller to correct or to not correct the defective pixel, and then outputting a display data; and
a recording unit, for recording the status data of the currently defective pixel detected by the controller, and providing the data to the controller to compare the status data with that in the next pixel line sensing data.

2. The image sensing device with pixel correction function of claim 1, wherein the status data of the defective pixel comprises non-defective pixel, or one dimension position data and dark/bright spot data.

3. The image sensing device with pixel correction function of claim 1, wherein the recording unit records the status data of the defective pixel in one pixel line.

4. The image sensing device with pixel correction function of claim 3, wherein the status data of the defective pixel comprises non-defective pixel, or one dimension position data and dark/bright spot data.

5. The image sensing device with pixel correction function of claim 1, wherein the regular pattern is a regular bright pattern or a regular dark pattern.

6. The image sensing device with pixel correction function of claim 5, wherein the regular pattern comprises a vertical lattice.

7. The image sensing device with pixel correction function of claim 5, wherein the regular pattern comprises a horizontal lattice.

8. The image sensing device with pixel correction function of claim 1, wherein the recording unit, in conjunction with the comparing result of the status data, records a suitable number of the defective pixels, to determine whether the defective pixel belongs to a regular pattern.

9. The image sensing device with pixel correction function of claim 1, wherein the suitable number of the defective pixels is for five or less than five previous pixel lines.

10. The image sensing device with pixel correction function of claim 9, wherein the regular pattern includes a curve pattern.

11. A method for correcting pixel sensing data, for receiving a pixel line sensed by multiple sensing pixel units to correct a pixel data of a defective sensing pixel unit, the method comprising:
(1) determining whether or not the received pixel line includes at least one currently defective pixel;
(2) if there is a defective pixel determined in step (1), determining whether or not the currently defective pixel belongs to a regular pattern by comparing with a stored previously defective pixel;
(3) if the step (1) determines as the regular pattern, maintaining a status data of the pixel and the pixel is not corrected;
(4) if the step (1) determines as not the regular pattern, appropriately correcting the currently defective pixel by referring to the pixels in the front and back of the currently defective pixel;
(5) recording a pixel line data of the pixel line, for adding to the previously defective pixel, and replacing a further previous pixel data of the previously defective pixel when the currently defective pixel exceeds a given capacity;
(6) if the step (1) determines a negative result or the pixel line is corrected through the steps (2) to (4), going to a pixel processing step; and
(7) if there is a next pixel line to be displayed, going back to the step (1), otherwise ending the process.

12. The method for correcting pixel sensing data of claim 11, wherein the given capacity in the step (5) comprises only one previous pixel line data.

13. The method for correcting pixel sensing data of claim 12, wherein the step (2) comprises:
(2.1) determining whether or not a previous pixel line contains the defective pixel;
(2.2) if the determination in step (2.1) is negative, going to the step (4);
(2.3) if the determination in the step (2.1) is positive, comparing whether the currently defective pixel is consistent with the previously defective pixel;
(2.4) if the determination in the step (2.3) is negative, going to step (4); and
(2.5) if the determination in the step (2.3) is positive, going to step (3).

14. The method for correcting pixel sensing data of claim 13, wherein the regular pattern is a lattice pattern in an image.

15. The method for correcting pixel sensing data of claim 14, wherein the lattice pattern is a vertical lattice.

16. The method for correcting pixel sensing data of claim 14, wherein the lattice pattern is a horizontal lattice.

17. The method for correcting pixel sensing data of claim 11, wherein the given capacity in the step (5) comprises five or less than five previous pixel line data.

18. The method for correcting pixel sensing data of claim 17, wherein the regular pattern is a curve pattern.

19. The method for correcting pixel sensing data of claim 11, wherein the pixel line data in step (5) comprises non-defective pixel, or one dimension position data and bright/dark point data.
